(19) United States
(12) Patent Application Publication
(10) Pub. No.: US 2013/0179320 A1
(43) Pub. Date: Jul. 11, 2013

(54) MONITORING AND COMMUNICATING CREDIT DATA IN A DERIVATIVES TRADING SYSTEM

(71) Applicant: RAYMOND MAY, Matthews, NC (US)

(72) Inventor: RAYMOND MAY, Matthews, NC (US)

(73) Assignee: ODEX Group, Inc., Matthews, NC (US)

(21) Appl. No.: 13/572,201

(22) Filed: Aug. 10, 2012

Related U.S. Application Data
(60) Provisional application No. 61/522,101, filed on Aug. 10, 2011.
(60) Provisional application No. 61/553,530, filed on Oct. 31, 2011.

(51) Int. Cl. G06Q 40/04

(52) U.S. Cl. CPC G06Q 40/04
USPC 705/37

(57) ABSTRACT

A credit monitoring system is configured to receive data on derivative trades associated with the trading entities, determine credit limit data associated with the trading entities, determine an amount at risk for each of the derivative trades and adjust the credit limit data based on the derivatives trades. The credit limit data and derivative trade data, and warnings about credit exposure approaching credit limits, may be communicated to the future commission merchants, enabling control and/or adjustment of the credit exposure of their respective trading entities. Advantageously, the monitoring system can also be expanded to include multiple swap execution facilities through centralized collection of the trading data from the swap execution facilities and/or from a swap data repository.

### CROSS REFERENCE TO RELATED APPLICATIONS

This application claims the benefit of U.S. Provisional Patent Application No. 61/553,530, filed on Oct. 31, 2011, entitled “Monitoring and Communicating Credit Data in a Derivatives Trading System,” and U.S. Provisional Patent Application No. 61/522,101, filed on Aug. 10, 2011, entitled “Monitoring and Communicating Credit Data in a Derivatives Trading System,” the disclosures of which are expressly incorporated herein by reference in their entireties.

### FIELD OF THE INVENTION

This invention relates to exchange trading platforms and, more particularly, systems or methods for monitoring credit of traders using derivatives trading platforms.

### BACKGROUND OF THE INVENTION

Until the passage of the Dodds-Frank Act (“DFA”), the majority of all over-the-counter (“OTC”) derivatives (defined by the DFA as a “swap”) were traded bi-laterally between two parties using standard legal contracts called international swaps and derivatives association (“ISDA”) agreements and credit support annex (“CSA”) agreements. In this environment the contracts stayed in place unless the two parties agreed to terminate the agreement by mutually agreeing an unwind price. As a result portfolios of deals tended grow and grow. Managing the large portfolios of bi-lateral portfolios produce many risk management problems.

With the introduction of the DFA, the majority of derivatives trades will be conducted electronically and cleared through a central clearing house. The result of this is to create a situation that the respective credit name or quality of two parties will no longer be relevant to the price of the initial transaction or the ongoing management of the credit profile. Instead all trades cleared through the same clearing house will in effect become fungible. Swaps with the exact same terms on different clearing houses may also become fungible.

The advantages of this system include freedom from concerns about credit risk and increased anonymity. Trades entered into by two parties no longer need to know the details of the other party and trading can be done anonymously.

A technical problem arises, however, as to how to efficiently and effectively communicate and execute the trades over distributed electronic networks of interconnected computer systems. Another technical problem is to overcome the limitations on information communicated between these parties now that they're forced to adhere to the standards set by the trading platforms.

Previously, in OTC trading, parties were free to vary terms of the trade to fit their individual circumstances and needs. After the DFA, trading data exchanged between market participants will be in standardized formats that inhibit the flexibility of transactions.

Improvements are desired in flexibility of communicating and processing derivatives trades in a post-DFA environment.

### SUMMARY

A system for monitoring credit exposure of trading entities trading derivatives on at least one open exchange is disclosed. The system receives trade data on agreed-upon derivative trades from the open exchange, wherein the trade data includes trading entity identification codes and contract description data. Also, the system determines credit limit data associated with each of the trading entity identification codes. An amount at risk is determined for each of the agreed-upon derivative trades using the contract description data. The amount at risk is assigned to each of the trading entity identification codes. And, the credit limit data of each of the trading entity identification codes is adjusted using the amount at risk. The adjusted credit limit data is communicated to one or more futures commission merchants. Also, the system may then communicate the trade data to a clearinghouse for settlement. Advantageously, because the system is aware of the amount of credit available to a trading entity associated with a particular trade, a swap execution facility running the system will be assured approval of the trade.

The credit limit may be a daily credit limit or may represent an overall credit limit over an entire trading history.

The system may communicate by displaying the adjusted, credit limit data for each of the trading entity identification codes on a GUI. Also, the trade data may be displayed for each of the trading entity identification codes on the GUI.

Also, the system may determine when the credit limit data has reached a threshold for one of the trading entity identification codes and can communicate a limit warning to one or more future commission merchants associated with the trading entity identification code.

Trading may be stopped by one of the trading entities associated with the identification codes in response to the credit limit reaching the threshold. For example, the system may receive a kill command from a futures commission merchant and then stop trading by the trading entity.

Also, the system may use trade data that includes a portfolio identification code associated with the trading entity identification code to facilitate internal allocation of trades by the trading entities. These portfolio identification codes may be communicated to the futures commission merchant.

The trade data may also include a futures commission identification code. This facilitates communication of the adjusted credit limit data to the futures commission merchant associated with the identification code.

The system's determination of credit limit data may include receiving a credit limit from the futures commission merchants. The credit limit data may be based, on a multiple of normal market trade sizes. Also, the amount at risk may be calculated as value at risk (V@R).

The system may also receive trade data from a plurality of open exchanges wherein the trade data includes open exchange identification data. The trade data for derivative trades, including the open exchange identification data, for each of the trading entity identification codes may be communicated to the future commission merchants. Also, the trade data may be filtered by identification codes associated with a particular one of the futures commission merchants. Only the data relevant to a particular futures commission merchant is communicated to that merchant. For additional security, the filter may remove price data from the trade data prior to communication to the futures commission merchant. Also, the trade data may be sorted and communicated based on closeness to trading.

Historic trade data and direction data (pay or receive) may be received by the system and communicated to the futures commission merchants. The system may use the direction and historic data to adjust the credit limit data. For example, the historic trade data may be used to offset (current) trade data, resulting in an increase in the credit limit despite an additional trade.

### BRIEF DESCRIPTION OF THE SEVERAL VIEWS OF THE DRAWINGS

FIG. 1 is a schematic of a credit line system for use with a derivatives trading system;

FIG. 2 is a schematic of another credit line system for use with a derivatives trading system;

FIG. 3 is a schematic of a derivatives trade using a clearinghouse and a swap data repository;

FIG. 4 is a graphical user interface of an administrator function of the system of FIG. 1 or 2 displaying a day's trades;

FIG. 5 is the graphical user interface of FIG. 4 displaying open orders;

FIG. 6 is the graphical user interface of FIG. 5 displaying a credit limit setting tab;

FIG. 7 is a schematic of a derivative trading system;

FIG. 8 is a flow diagram of a derivative trade execution system;

FIG. 9 is a graphical user interface of a trading screen for standardized swaps;

FIG. 10 is a schematic of a network entity for monitoring and communicating a credit line in derivatives trading;

FIG. 11 is a schematic of a derivatives trading system; and.

FIG. 12 is a schematic of a margin hub system.

### DETAILED DESCRIPTION

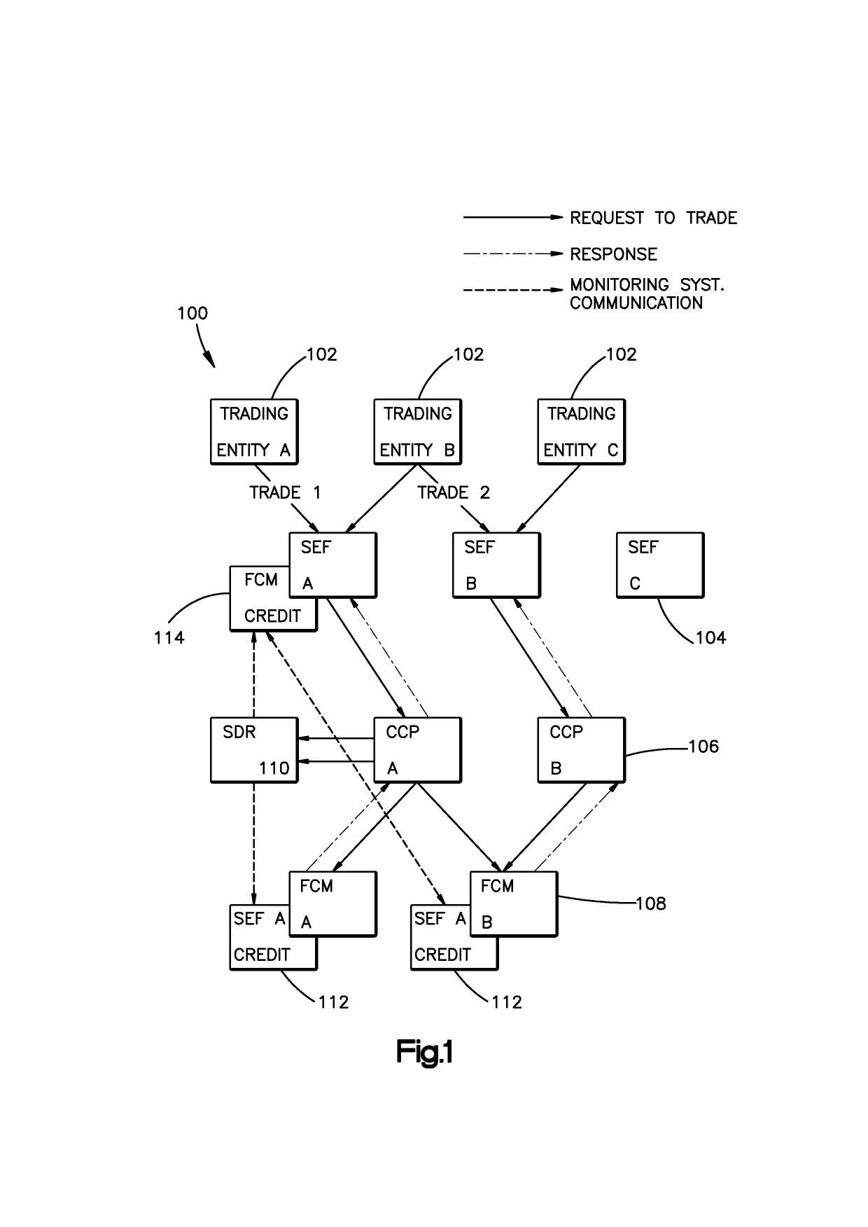

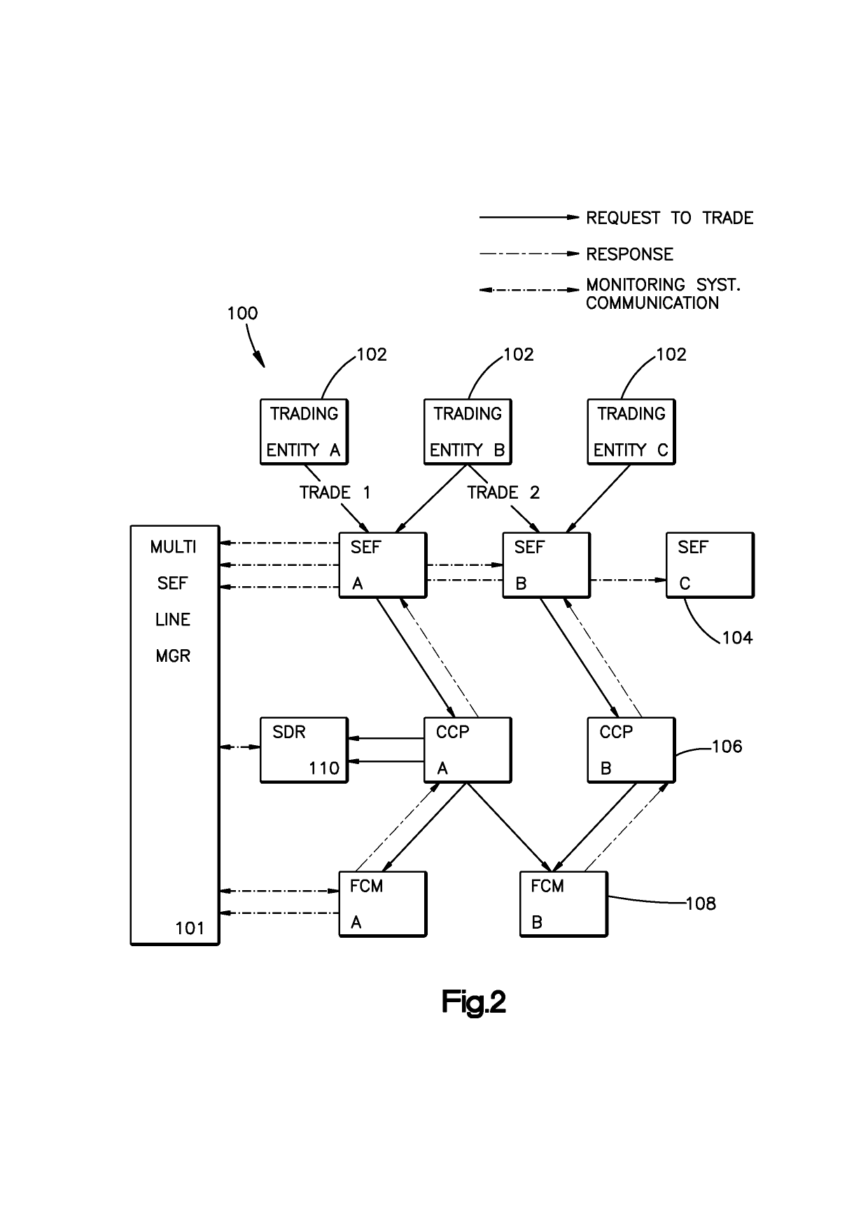

With reference now to the accompanying FIGS. 1 and 2, for example, embodiments of the present invention include systems, methods and computer programs 100 for monitoring and/or communicating credit exposure of trading entities 102 trading derivatives on one or more open exchanges and being processed by swap execution facilities (SEFs) 104 for clearance on clearinghouses (CCPs) 106 based on credit extended by future commission merchants (FCMs) 108.

The monitoring system 100 is configured to receive data on derivative trades associated with the trading entities 102, determine credit limit data associated with the trading entities 102, determine an amount at risk for each of the derivative trades and adjust the credit limit data based on the derivatives trades. The credit limit data and derivative trade data, and warnings about credit exposure approaching credit limits, may be communicated to the FCMs 108, enabling control and or adjustment of the credit exposure of their respective trading entities 102. Advantageously, the monitoring system 100 can also be expanded to include multiple SEF's through centralized collection of the trading data from the SEF's and/or from a swap data repository (SDR) 110.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed, elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Under the Dodd-Frank Act (DFA) there will be new rules that mandate central clearing of derivatives that were previously traded over the counter (OTC). Also, a separate mandate will require these trades to trade electronically on one of the SEFs 104. In addition, all trades will be mandated to be reported to the SDR 110 within 15 minutes of the trade.

An additional issue is the number of parties involved, including the execution venue, the clearing house and the clearing member. The clearing member will be responsible for collecting margin and setting trading limits. Problems arise with communication between these parties.

There is an additional issue if the credit decision being addressed only at the open exchange. For example, if two entities trade on the SEF, but one is over their limit, the trade will be later decayed by the open exchange and this is not a good situation.

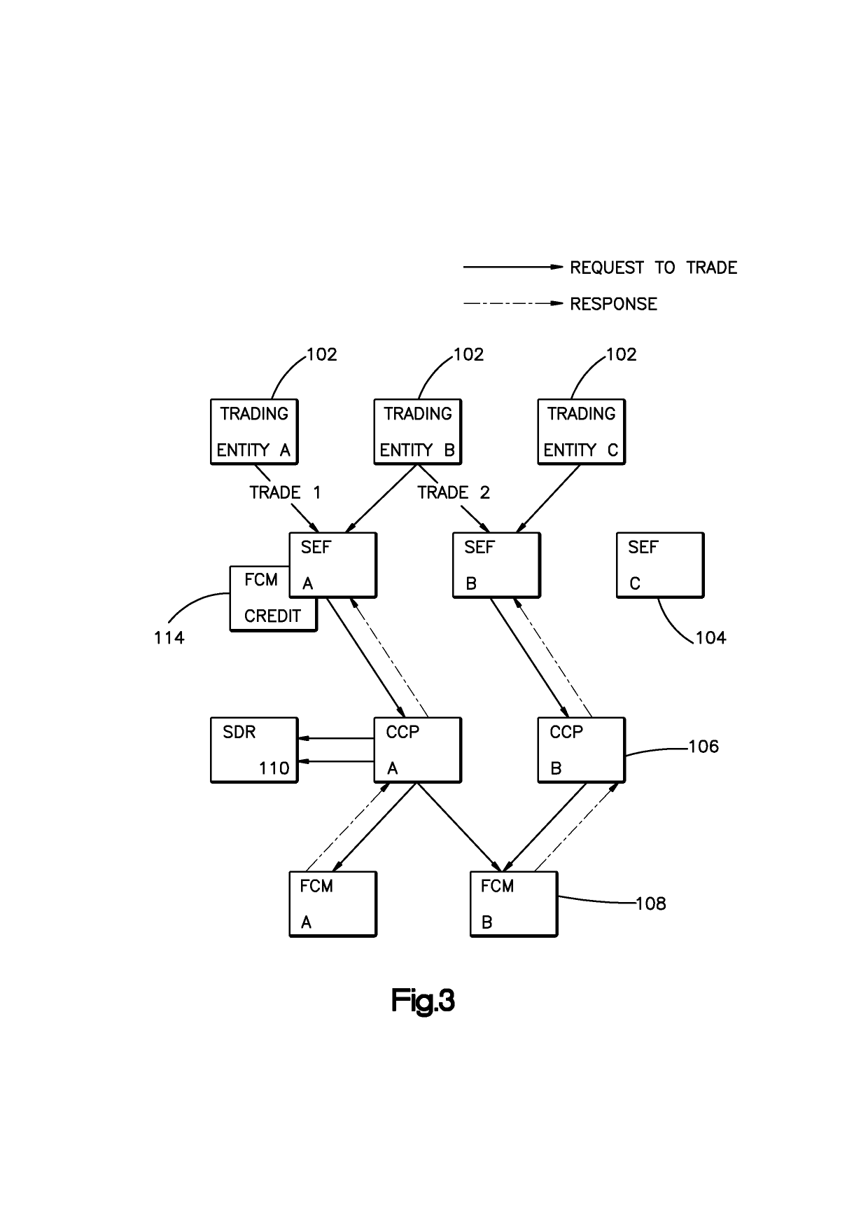

Referring to FIG. 3, the trading entities 102 include any legal entity—bank, hedge fund, corporation, etc.—which falls under the DFA and which wishes to trade in these markets. However, this will only be open to the very largest entities, and it therefore appears likely that trading entities 102 will have to set up accounts with CCPs 106 through a CCP clearing member or through an FCM 108. The FCM 108, then, will be responsible to collect initial and variation margin from its members on behalf of the CCP 106 and manage the trading limits of each trading entity 102.

FIG. 3 illustrates the transaction as it would occur under DFA. The trading entity A has a trading account with FCM A, trading entity B and C have trading accounts with FCM B. In turn, trading entities A and B have execution accounts to trade with CCP A via SEF A. And, trading entities B and C have execution accounts to trade with CCP B via SEF B.

In FIG. 3, the work flow for trade 1 (wherein the request to trade is in solid lines and the response is in broken lines) requires trading entities A and B to match on price at SEF A, SEF A sends the trade for approval and clearing to CCP A. CCP A checks the current status of the accounts with FCM A and FCM B and, providing the accounts are in good standing, will approve the trade and send an approval message back to SEF A.

Generally, the CCP A has two levels to check, first that the FCM is in good standing and second if each sub account is in good standing. Once the trade is cleared the CCP is responsible to send the trade report to the SDR. All of this must occur near instantanously (miliseconds or fractions of a second v. hours or days) for the trade to be anonymous. Material trades could lead to decay or cancellation of the trades.

The inventors have observed that this workflow may present the issues for an FCM's ability to manage multiple SEFs. Also, each SEF might not know whether a trade will be approved. Each of these uncertainties will add to the delay and possibly jepoardize clearing, execution or anonymity.

Referring again to FIG. 1, the monitoring system 100 includes trading entities 102, SEFs 104, CCPs 106 and FCMs 108 interconnected by lines indicating information flow on various communication systems, such as an electronic network, as facilitated by the system 100. Trading entities 102 in the system 100 are defined as legal entities with unique customer identifiers (UCI) or some other identification code (wherein a code may even be just the name or abbreviation of an entity). This code will identify the trading entity and the trading entity itself may represent multiple porfolios, traders and/or users. The system 102, for simplicity, however, may be designed to only deal with UCI's and not sub-divisions within each trading entity.

An FCM is a clearing member of one or more CCP's, examples are JPM Prime Broker Services, Barclays Capital Prime Broker Services, etc.

A trading user in the system 100 can trade on behalf of one or more trading entities (UCI's) and/or one or more portfolios withn a UCI, however each trade should have a UCI and associated FCM 108. For example, Blackrock manages more than 3000 funds and each fund is a separate legal entity indicated by a UCI. But each fund may have more than one sub-portfolio and more than one trader with permission to trade. In addition a single trader may have permission to trade on behalf of more than one fund or portfolio. A porfolio is not a UCI however, just a method to allow users to segregate trades for internal reasons. Each UCI may have accounts with more than one FCM 108, however at least one FCM should be associated with each order.

In the case of allocations—a single large trade is made on behalf of many funds—the allocation can be made pre-trade or post-trade. In the case of pre-trade the order may contain a percentage allocation for each fund (UCI), and each fund (UCI) may have different FCM. The SEF 104 would break this trade up and distribute the portions to the respective FCM's 108 and CCPs 106.

Regardless, returning to FIG. 1, one or more of the SEFs 104 may host the system 100, or the system may be operated on a distributed computer system with GUI or other access available to the SEFs 104, FCMs 108 and possibly the CCPs 106 and/or the trading entities 102 in selective ways. In FIG. 1, the SEF A provides the system 100 to connect each FCM 108 with the SEF A to set daily trading limits. Thus, the system 100 enables the FCM A to see all trading entities 102 that have registered with FCM A and are using FCM A in a trade.

The system 100 is configured to perform a number of operations, such as 1) obtaining and setting a daily trading limit for each trading entity 102, 2) obtaining and communicating active orders for each trading entity hosted by an FCM 108, 3) sending out a limit warning when a trading entity nears its daily trading limit (e.g., when only 25% of the limit remains) and 4) enabling the FCM to increase the daily limit or hit a “kill switch” to stop trading by the trading entity.

The system 100 may include an interface 112 accessible by the FCM 108 and an administrative interface 114 which is accessible to the hosting SEF 104, as shown in FIG. 1. The administrative interface 114 accessible by the SEF 104 allows the SEF to 1) monitor trade execution, 2) view open and used credit lines and 3) view and monitor lines to facilitate communication between trading entities 102 and the FCM 108.

The administrative interface 114 may host various functions via tabs on a display, that include a list of orders, including active sitting orders sorted by those closest to mid-market; requests for quotes (RFQ) that are active and in process, along with the ability to see the requestor and responses to date; and the line manager, sorted by UCI/FCM showing the line, amount available and amount used. The interface 114 may highlight important status information, such as making a credit line with an active kill switch red.

The system 100 is configured to set credit limits against a complex array of OTC derivative structures based on inputs communicated by an interface 112 accessible to the FCM 108. These limits, for example, may be set using DV01, notional by instrument class or a V@R measure. For example, the FCMs may provide a “line” that will allow the trading entities to do some trades—say 3 trades of normal market size—for monitoring during the day. This limit may be monitored by the FCM and reset when desired or further trading can be killed through the system 100.

In another example, a Value at Risk (V@R) model (V@R used herein refers to a specific model, while “value at risk” refers to a more general concept of quanitification of risk in taking a position) uses the distribution of market moves and finds the worst case possible market price move of the instrument for the next 24 hours—the period to be transferred into the full clearing model. The model uses a 3 standard deviation price move of ail instruments traded. It is possible, in this and other models, that a second trade reduces risks of the daily portfolio and the V@R model takes this into account by accounting for a direction of the trade.

DV01 values are calculated based on the yield of U.S. interest swaps. Table 1 below, for example, displays the values calculated in July of 2011.

TABLE 1

| UPI* | DVOI |
|---|---|
| 3-MO | 0.249 |
| 1-YR | 0.996 |
| 2-YR | 1.975 |
| 3-YR | 2.322 |
| 4-YR | 3.823 |
| 5-YR | 4.679 |
| 6-YR | 5.487 |
| 7-YR | 6.237 |
| 8-YR | 6.976 |
| 9-YR | 7.678 |
| 10-YR | 8.330 |
| 12-YR | 9.619 |
| 15-YR | 11.332 |
| 20-YR | 13.632 |
| 25-YR | 15.311 |
| 30-YR | 16.458 |

DV01 is defined as the price change in dollars resulting in a yield change of 1 basis point (bp) which is 1/100^{th} of one %).

Modified duration, on the other hand, is a derivative or price sensitivity and measures the percentage rate of change of price with respect to yield. Price sensitivity with respect to yields can also be measured in absolute (dollar) terms, and the absolute sensitivity is often referred to as collar duration, DV01, PV01, or delta (δ or Δ) risk. The concept of modified duration can be applied to interest-rate sensitive instruments with non-fixed cash flows, and can thus be applied to a wider range of instruments than can Macaulay duration.

Returning to DV01, each instrument (as identified by UPI) uses a stored DV01, such as those listed in Table 1. Generally, DV01 values are very stable and are a function of the level of interest rates. A forward 2 year starting in 2 years, for example, has a DV01 of the 4 yr minus the 2 yr (3.823−1.978=1.845). The system 100 will calculate and store DV01 for every UPI.

An example illustrates the use of DV01 to determine the impact of a trade on the credit line of a trading entity with a FCM line of $50,000. The entity first trades 10 mm 2 yrs—paying, resulting in a deduction from the credit line of $10 mm*1.978/10000=$1,978. Notably, the first trade always reduces the line irrespective of direction. The line now has S50,000−$1,978=$48,022 remaining.

If the second trade is another 2 yr trade of $10 mm again—paying, there is a second deduction of $1,978 to $46,044 ($48,022-$1,978). Note that if any trade would exceed the credit line, the system 100 would alert the trading entity.

If the second trade is a 2 yr of $20 mm and receiving, instead of paying, a fixed rate, the line is actually increased. The first $10 mm would take the line back to $50,000 and the second $10 mm would reduce it again to $48,022, leaving the amount of unused line unchanged.

If the second, trade was $20 mm 5 yrs receiving instead of a 2 yr receiving, the line amount is $20 mm*4.679/10000−$9,358.

However a 5 yr is not the same as a 2 yr and the offset should not be 100%, this is where the Value at Risk model comes in by taking into account the correlation between the two trades. In option 1 (no v@r) this first build, it will be assumed there is a 1 correlation and all UPI will be trade alike only separated by pay or receive.

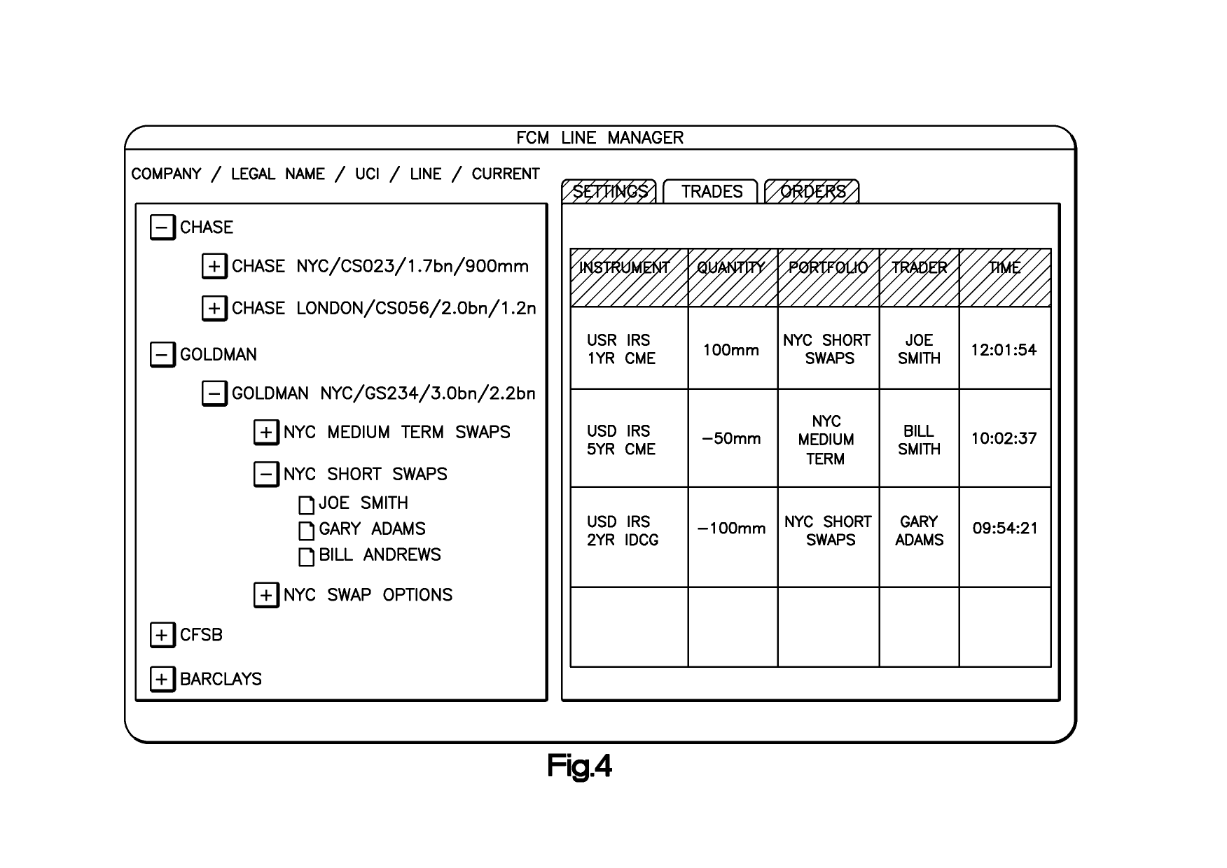

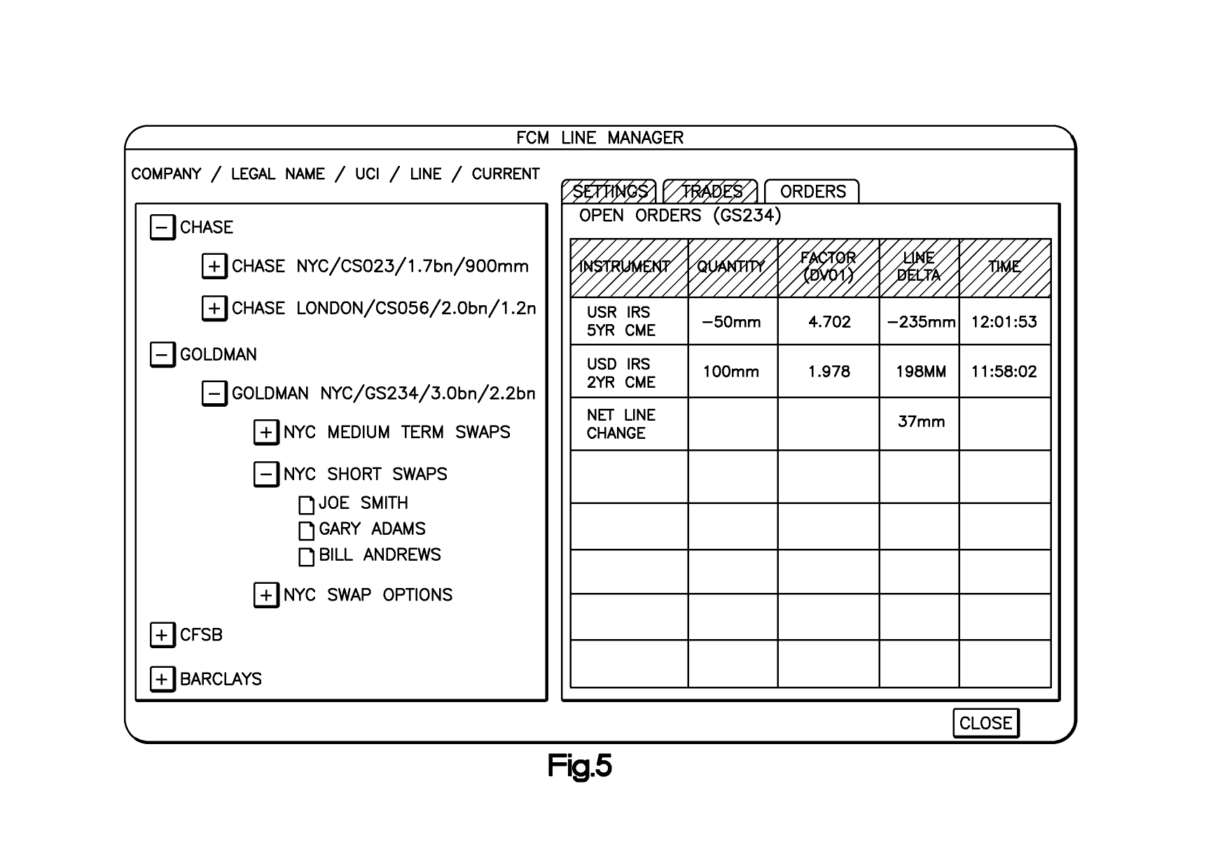

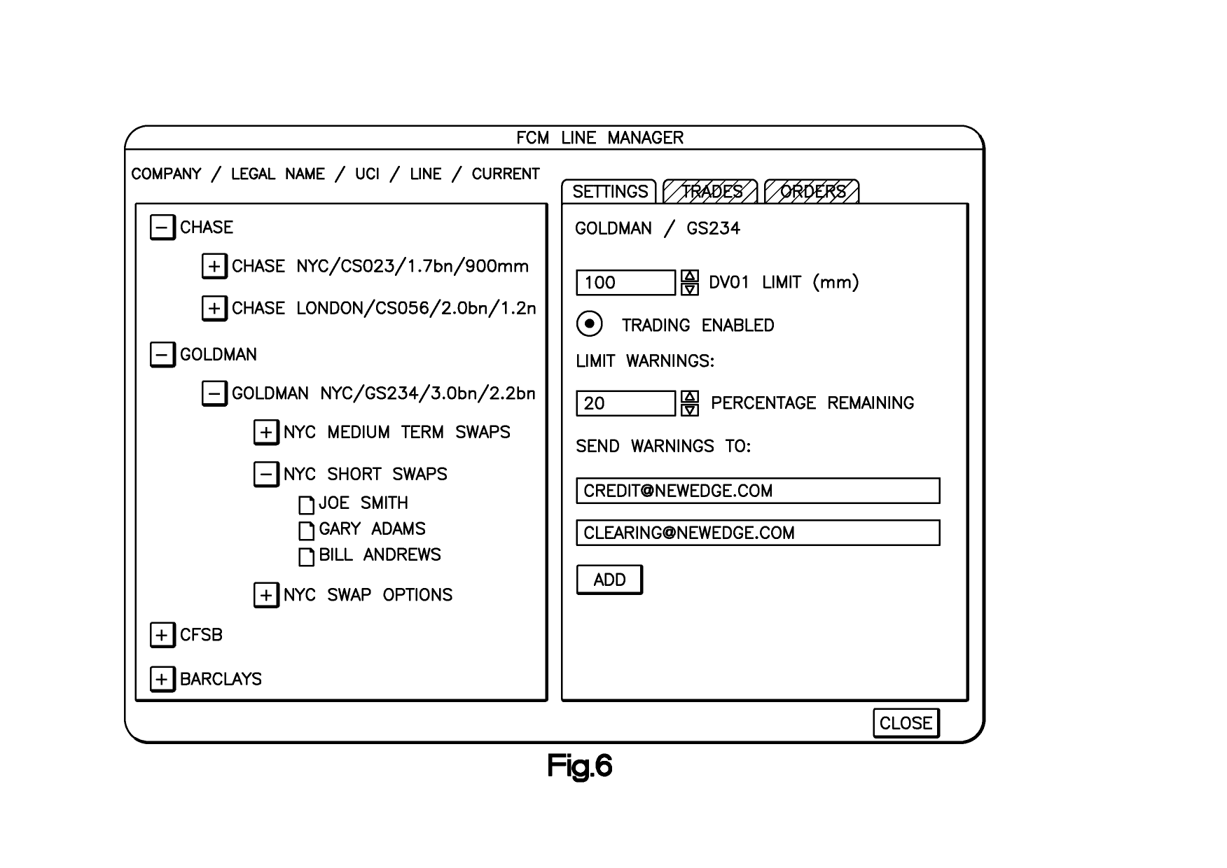

Referring again to FIG. 1, the interface 112 of the system 100 accessible to the FCM 108 provides a window into trading entities 102 with accounts at SEF A using each that particular FCM. Optionally, an FCM may be willing to share position information, such as information not taken from an SDR. It shows all of the executed trades for the day (FIG. 4), a daily usage of line (FIG. 5), a kill switch and the active orders. The interface 112 also provides the FCM the ability to set a daily credit limit for a trading entity, as shown in FIG. 6, including a percentage threshold for a limit warning. Generally, the interface 112 only shows the FCM 108 their own account holders that are using the FCM for the active order. It is possible for a trading entity to have more than one FCM account, however they usually will select a single FCM for each active order.

FIG. 2 shows the system 100 including a multiple SEF line manager function 101 that interconnects different CCPs 106 in addition to multiple FCMs 108 and includes communication with the SDR 110. This addresses the problem of different trading entities 102 using multiple FCMs 108 and SEFs 104 that normally would interefere with management of the true full position of a trading entity and to allocate exposure of the trading entity over more than one SEF.

The UCI described above is useful in implementing the multiple SEF line manager as it is consistent with all of the parties in the workflow, including the trade being reported to the SDR 110. The FCM sets a daily V@R limit against their accounts and each SEF accesses the system 100 prior to a trade to ensure the line is approved before the execution is completed. Access to the SDR 110 provides information for the historical position held by the trading entity, allowing, for example, a risk reducing position to be reflected against yesterday's position.

Each FCM would be able to acces the system 100 for their accounts and set a daily trading limit; see all active orders for their account holders (excluding price to preserve confidentiality) but sorted closest to trading; see a 25% (or other perecentage) limit warning—allowing the FCM to increase the daily limit and initiate a kill switch to stop trading.

The multi-SEF line manager could be extended to include the total historic portfolios for each trading entity 102, such as by accessing the SDR 110. This allows for improved assessment of the credit risk associated with the trading entities by the FCMs 108. For example, if a trading entity trades $100 mm interest rate swaps (IRS) on Monday fully using the line in the system 100. On Tuesday it can trade another S100 mm. If this second trade is in the same direction the risk is double, if the trade is in the opposite direction the risk combined position reduced the resulting risk to almost to zero. A history limited to intraday would not capture either of these scenarios.

In more detail, assume the SEF 104 has listed for trading any date combination of IRS and 3 month forward rate agreement (FRA). This is a large number of instruments—IRS can have tenors of 6 months, one year, two years, three years out to thirty years with a start date any time in the past or future. Other differences include a set fixed rate, changes in calculation basis, floating indices etc. For FRAs these can trade for any 3 month period in the future. Each has a unique product identifier (UPI).

Trading entity A provides FCM $3 mm of initial margin and is allowed to trade with a daily V@R of $1 mm based on 99% confidence. In day one, the trading entity A has no positions. In day two, the trading entity A trades $10 MM 2 year IRS paying the fixed rate. The expected variance (V@R) is $2,000, well below the trading limit.

For this example, the message flow distributed by the system 100 may be:
1. Trading entity A enters order to pay on $10 mm 2 yr IRS cleared at CCP A, using FCM A
2. SEF A sends the UPI, quantity and direction (pay) to the multi-SEF line manager
3. The line manager system 100 would calculate the change in the V@R which is $2000, determine that this amount is below the line set by FCM A and return an “approval” message to SEF A
4. For sitting orders this check will have to continue at reasonable intervals.
5. The order is executed and SEF A sends the trade record to CCP A, which in turn would approve the execution internally or in conjunction with FCM A (and the FCM of the other party)
6. Once approved then CCP A reports acceptance of the trade back to SEF A
   This should all occur in nanoseconds, and SEF A has high confidence that the trade will occur correctly.

On day three, trading entity A trades $100 mm 10 year IRS paying the fixed rate. This has expected variance of $100,000 and the message flow may, for example, be:
1. SEF A sends the UPI, quantity and direction (pay) to the multi-SEF line manager
2. The line manager system calculates the change in the V@R which is $102,000 (assuming a perfect correlation), determines this is below the line set by FCM A and returns an “approval” message to SEF A

If the trading entity A traded $1000 mm on day three, however, this would exceed the limit of $1 m, and if the trading entity had received and not paid on $100 mm the line usage would be $98,000 as the trades offset based on a 99% v@r model.

Thus, if a trading entity has a portfolio of X made up of many contracts executed in the past of many instruments, this portfolio has a v@r of x. When a new trade Y is added to portfolio X, the v@r is recalculated and the change in v@r caused by Y is a new x′. The change may be positive or negative. And providing x′ is less than the limit set the new trade Y is allowed.

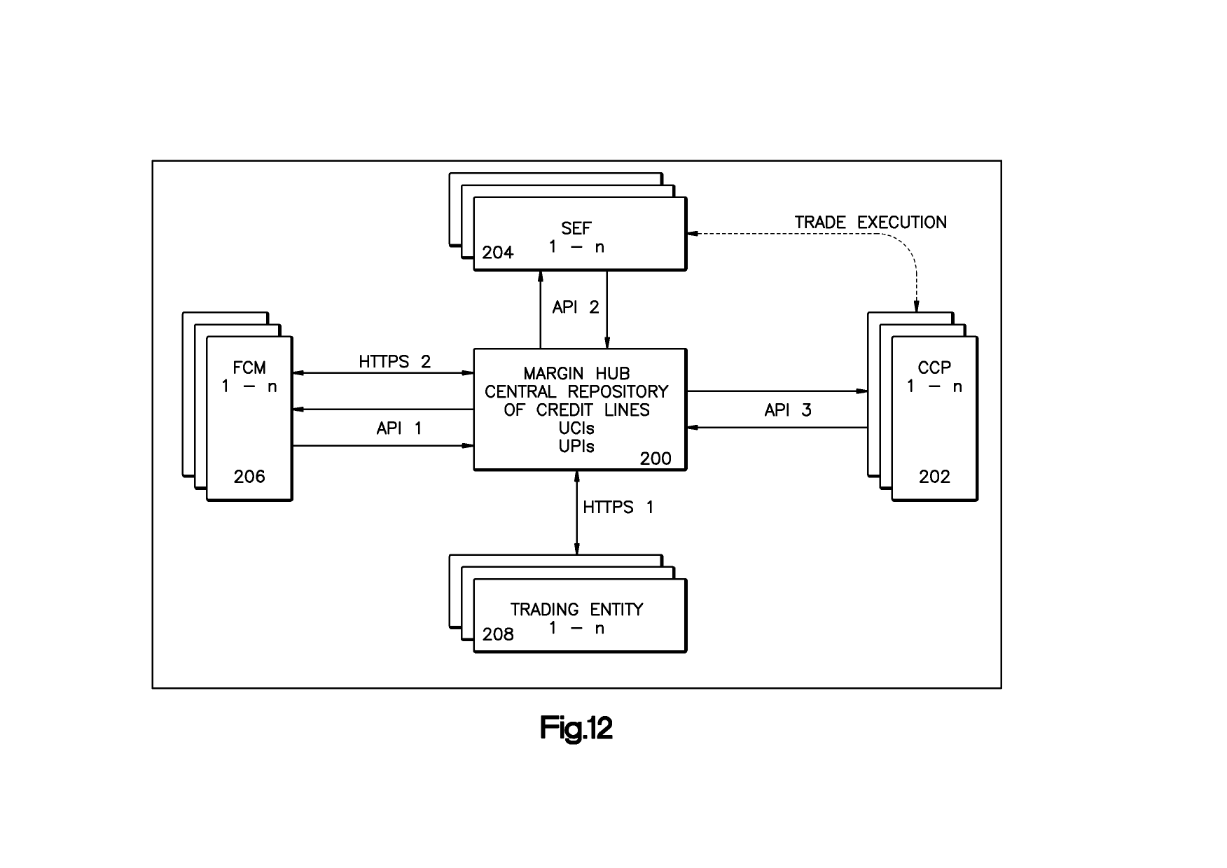

The multi-SEF line manager may also be characterized as a margin hub 200, as shown in FIG. 12. As mentioned above, the new regulation requires for contracts previously traded bi-laterally to be cleared through central clearing parties (CCPs) 202 and executed on swap execution facilities (SEFs) 204. The margin hub 200 advantageously can provide a pre-trade confirmation that the trade will clear on a credit basis. Future commission merchants (FCMs) 206 are clearing members responsible for managing margin and access to the CCPs 202 for the trading entities 208. The margin hub 200 facilitates trading by, for example, providing SEFs 204 immediate access to credit lines set and managed for each of the trading entities 208, which are clients of one or more of the FCMs 206.

All components of the structure may, advantageously, use the same terminology especially in identifying contracts (Unique Product identifiers—UPI), customer (Unique Customer Identifiers—UCI) and the trading ability or credit line provided for each UCI by the FCMs 206.

The margin hub 200 is configured to provide APIs (Application Program Interfaces) configured to enable users to access a centralized margin hub database to update credit lines, add UCI and hold lines for trading.

Referring again to FIG. 12, for example, API 1-FCM is configured to add trading entities 208, add lines (for trading on individual CCPs 202) based on financial strength of each trading entity 208 and an amount of initial margin paid in by the trading entity 208 and held by the FCM 206 on behalf of each CCP 202. Additional functions provided by the API-1 are:
add a new trading entity if the trading entity 208 is new to the margin hub 200 and has no UCI
create an account for an trading entity 208 that is registered and has a UCI
update a credit line for trading limits based on IM (Initial Margin, DV01, v@r) for each asset class and CCP 202, or in the aggregate
update upon execution of a trade

The API-2 is configured to facilitate SEFs 204, with a minimum of literacy, to access credit lines set by FCMs 206 for each trading entity 208 wishing to trade/execute on each SEF. Messages include UCI lists, FCM lists, UPI lists to facilitate data mapping to the central database of the margin hub 200. The SEF can therefore check line availability for each trade order at the time the trade order is placed, hold the necessary credit line, report the trades and/or release previously held lines.

The API-3 is configured to facilitate CCPs 202 access to the central database and setting of lines against FCMs 206 and access trading entity 208 data for each FCM. Also, the API-3 provides an ability to update UPIs for contracts available through the CCP.

The HTTPS-1 is a secure web eservice for the FCM 206 to monitor and view data in the central database on the margin hub 200.

The HTTPS-2 is a secure web eservice for trading entities 208 to monitor and view their data in the central database on the margin hub 200.

The trade execution broken line indicates trade execution messages between SEFs 204 and CCPs 202 to confirm transactions. Optionally, this trade execution message could contain the credit hold or approval from the margin hub 200 as part of the data contained in the message.

An advantage of the centralized margin hub 200 is that it is disassociated with any of the other entities such as the CCPs 202, SEFs 204, FCMs 206 or trading entities 208 so that it can maintain a trusted intermediary function, facilitating secure maintenance of confidential trading and credit information. To this end, the centralized margin hub 200 may be isolated from the other entities on a hardware and software security front and require the use of HTTPS communication protocols.

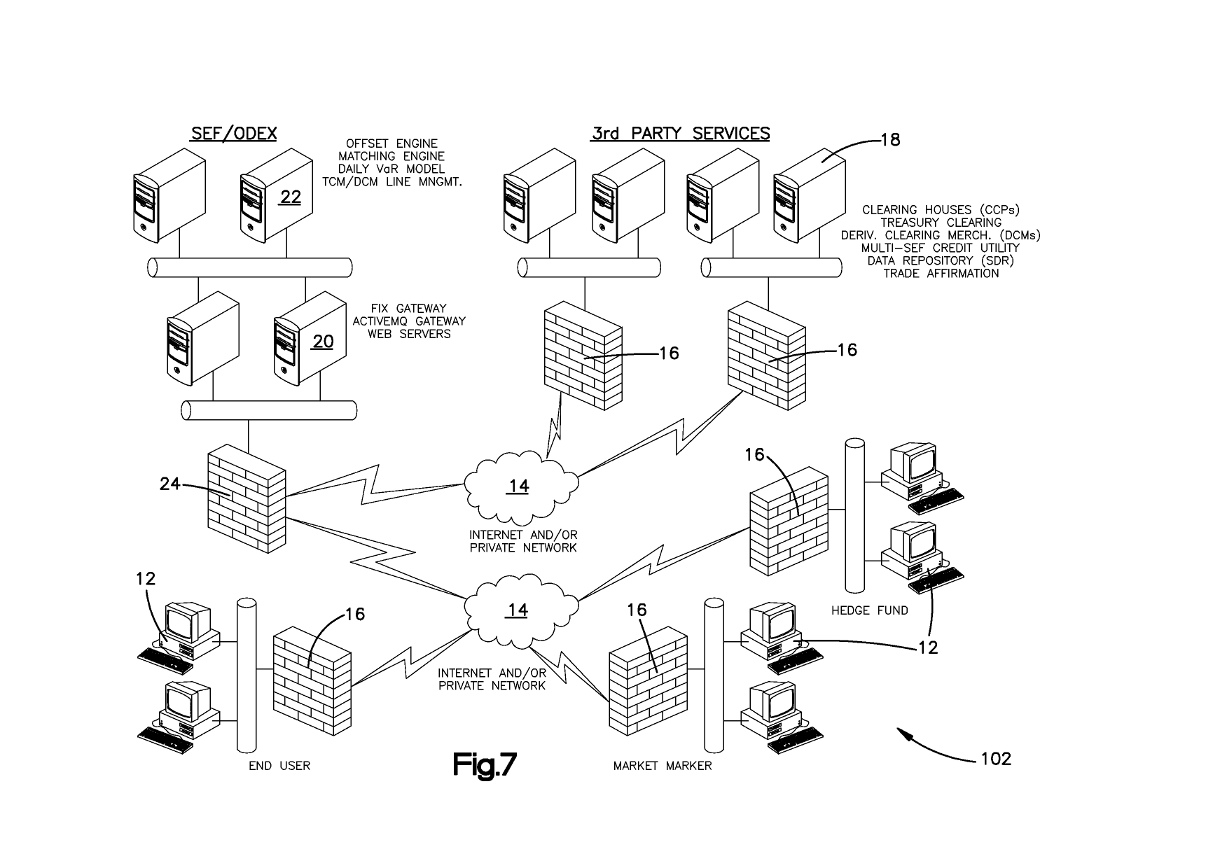

As shown in FIG. 7, a distributed network system 10 for performing derivative trades includes traders 12, internet or network connections 14, firewalls 16, third party services 18, messaging gateways 20 and swap execution servers 22. The swap execution servers 22 are configured to perform a plurality of derivative trading functions associated with a swap execution facility behind a firewall 24 and external communication is via a plurality of messaging gateways 20.

The traders 12, including hedge funds and market makers, are all end users that are trading over client terminals linked via message gateways over the network 14 and communicating with the swap execution servers 22. The client terminals, as described above, can be a range of computer or other electronic systems, including personal computers, mainframes or more customized systems configured to communicate, receive and display trading data for derivatives and other instruments between the traders and swap execution servers 22

The network 14 is represented in FIG. 7 generally as a single cloud but can include different individual and combined systems of interconnection for communication between the parties. For example, the network 14 may be the internet, a wireless network or a local-area-network (“LAN”) or combinations of all three.

The third party services 18 include clearinghouses that are centralized entities configured to receive information on trades and then intervene between the entities as a trusted intermediary to reduce counterparty risk. Although the trades are agreed to between various traders, each of those entities, after clearing, becomes a counterparty to the clearinghouse. The clearinghouse systems, then, are configured to break data on a single trade into two mutually opposing information datasets representing two mutually opposing contracts. Each of those contracts is with the clearinghouse itself, eliminating the counterparty with which the original agreement was made. The clearinghouses may also perform treasury clearing.

The third party services 18 may also include a derivatives clearing merchant configured to provide general post-trading processing and workflow for derivatives contracts, often in communication with the clearinghouses. Each of the clearinghouses and clearing merchant include a firewall 16 for security since they contain sensitive, confidential financial information and various servers for performing their functional processing of the trading data received through the network 14.

The firewall 24, similar to the other firewalls 16, is configured to guard confidential information and mediate access to and from the matching engine servers 22 upon which is stored sensitive, confidential information. The messaging gateways 20 are hardware or software that are configured to convert messaging protocols between the matching engine servers 20 and the protocols needed for the various configurations of network 14 and with the third parties 18 and the different traders 12.

The matching engine servers 22 of an embodiment of the present invention are configured with a plurality of computer modules for executing functions including matching bid and offers, storing order books, instrument definitions, permissions, trade data, analytical models, current market prices, customer and trade databases, an API for linking to the clearinghouses. The matching engine servers 22 have additional modules configured to execute trade matching and other functions of the system 100 described herein including calculating V@R, credit line management and offset determination. Offset determination and other functions performed by the matching engine servers 22 include functions performed by the matching engine servers described, in U.S. patent application Ser. No. 61/374,681 entitled COMMUNICATION AND PROCESSING SYSTEM FOR DERIVATIVE OFFSETS filed on Aug. 18, 2010 attached hereto or incorporated herein in its entirety by reference.

The third party services 18 may also include modules for executing functions of the system 100 including aspects of the multi-SEF credit line, the SDR 110 and trade affirmation services.

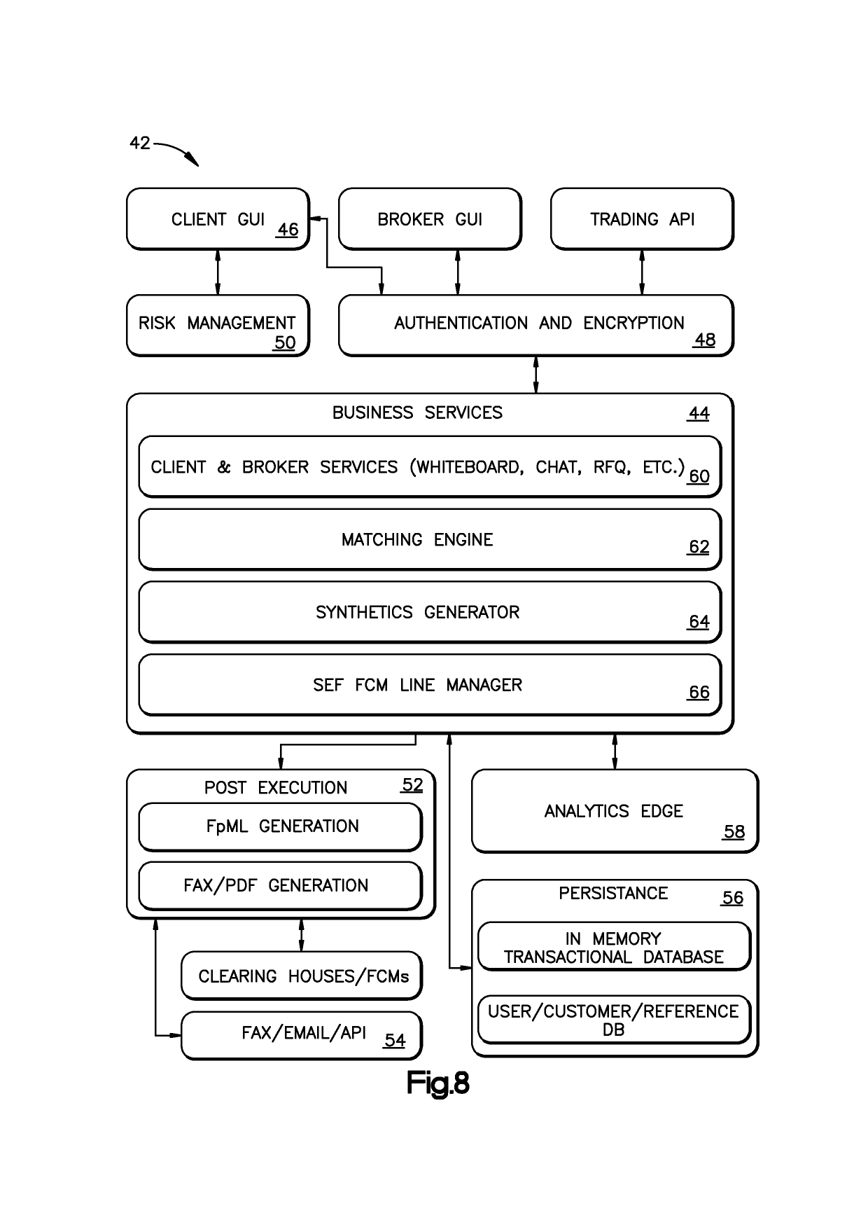

An entire swap execution facility 42 is shown in FIG. 8 that includes a business service system 44 that communicates with various trader GUI's 46 through a front end system that includes authentication and encryption modules 48 and a risk management module 50. The business service 44 is also configured to communicate with backend systems that include a post-execution module 52 that intermediates with clearinghouses 14 via an API 54, a database 56 and an analytics edge module 58.

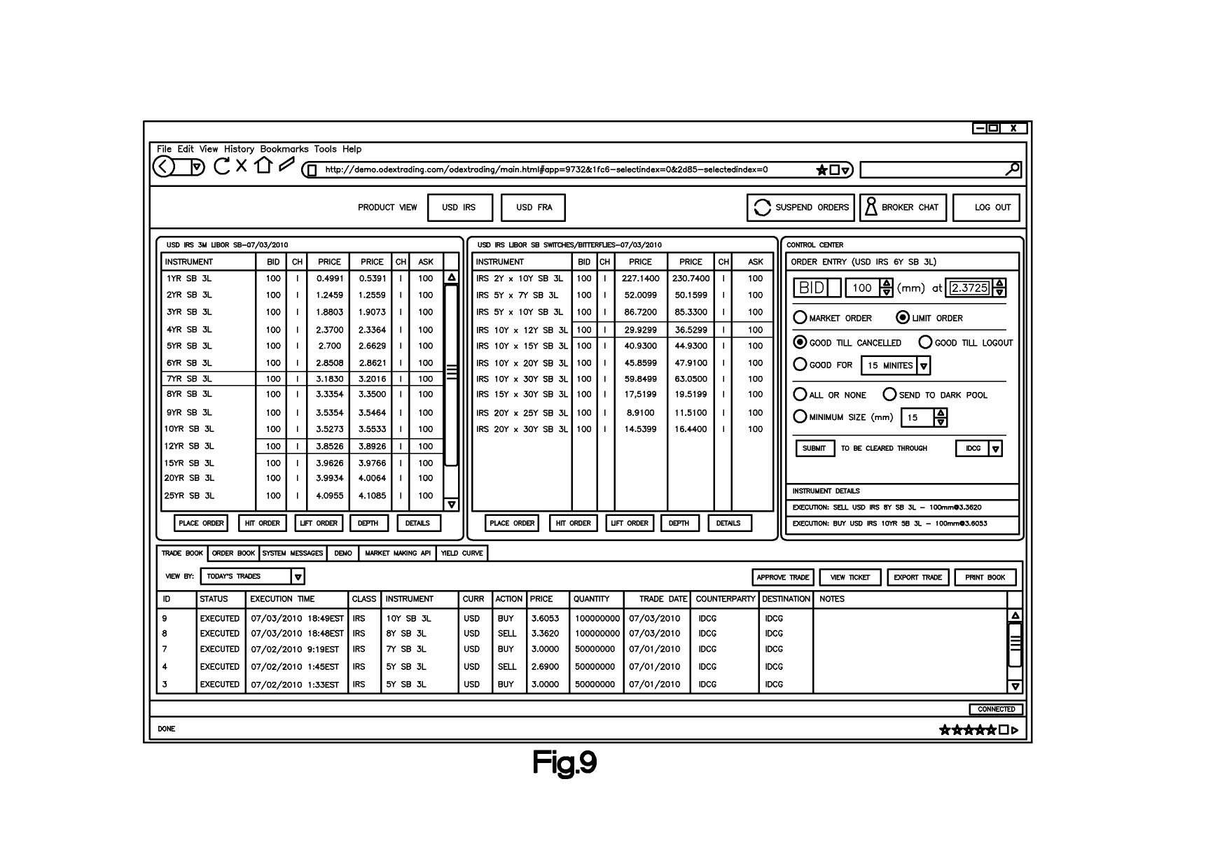

The trader GUI's 46 are configured to allow interface with the business service system 44 by the various traders including individual traders 12. An example of such a GUI is shown in FIG. 9, which is configured to allow users to post prices and execute transactions on standardized tenor trades in the post-DFA environment. The GUI shows a benchmark tenor trading screen of interest rate swaps clearing through a clearinghouse 14. To reduce the complexity of locating mismatches, the GUI allows the user to select a range of dates to consider when locating them. The GUI also is configured to communicate with the risk management module 50 which may include components of the system 100 for tracking and reporting credit lines of traders to SEFs and FCMs.

Regardless of the operations being performed, the GUI preferably communicates through the authentication and encryption modules 48 that ensure secure communication between the business service system 44 and the traders.

Returning to FIG. 3, the business services system 44 includes a combination of functional modules facilitating services, such as client and brokerage services 60, a matching engine module 62, a synthetics generator module 64, and an SEF/FCM line manager module 66.

The client and brokerage services 60 include communications functions such as user-to-user chat, request for quote (RFQ) and a whiteboard to host non-tradable intent to trade prices. Also, the services 60 may include back loading of transactions that were executed in another medium, such as OTC derivatives traded prior to the DFA and which are now being cleared by the clearinghouses under the DFA, and having mismatched, pairs of swaps that need to be offset with mismatches of other parties.

The synthetics generator module 64 is configured to generate spread trade of a buy and a sell of two duration weighted instruments. For example, a 2 year swap can be traded against a 5 year swap wherein the years are weighted and a price difference determined between the two. This enables trading of instruments of two different durations. The module 64 continuously calculates the duration of all instruments, posting the best bid or ask based on the respective markets in the underlying instrument and (also) allowing direct bids or offers for the synthetic spread if a 2 year and 5 year instrument are to be swapped.

The matching engine module 62 is configured to operate order books of live, tradeable bids and asks, and manual and automatic matching of trades, which are then passed through post execution module 52 for clearing. Notably, the matching engine module 62 can process trades by parties of offsetting mismatches (as a component of the distributed network system 10) as well as conventional swap trades.

The SEF/FCM line manager module 66 (as a component of the system 100) is configured to facilitate communication between SEFs and FCMs to manage credit of various trading entities, as shown, for example, in FIG. 1 or 2.

The analytic edge module 58 is configured to calculate the current market price (e.g., using the yield curve) of all market tradable instruments to allow accurate valuation of offset possibilities by the offset module 66. And, the module 58 is further configured to indicate the current price at which such trades could or should, be executed to be fair to both parties.

The database 56 represents a persistence layer configured for receipt and long-term storage of all dates, transactions, tradeable instruments, instruments that have traded, historical price information, customer data/permissions, current prices, order books, etc. to facilitate operation of the SEFs.

The post-execution module 52 is configured to receive trade data from the business service system 44 and convert the executed trade into a standard mark up format, such as FpML. This converted, trade is then passed, (preferably automatically) to the clearinghouses 14, such as through the API 54 hosted by the clearinghouses, and through the traders own systems. Other modes of data communication may be used, such as e-mail, fax and/or pdf generation.

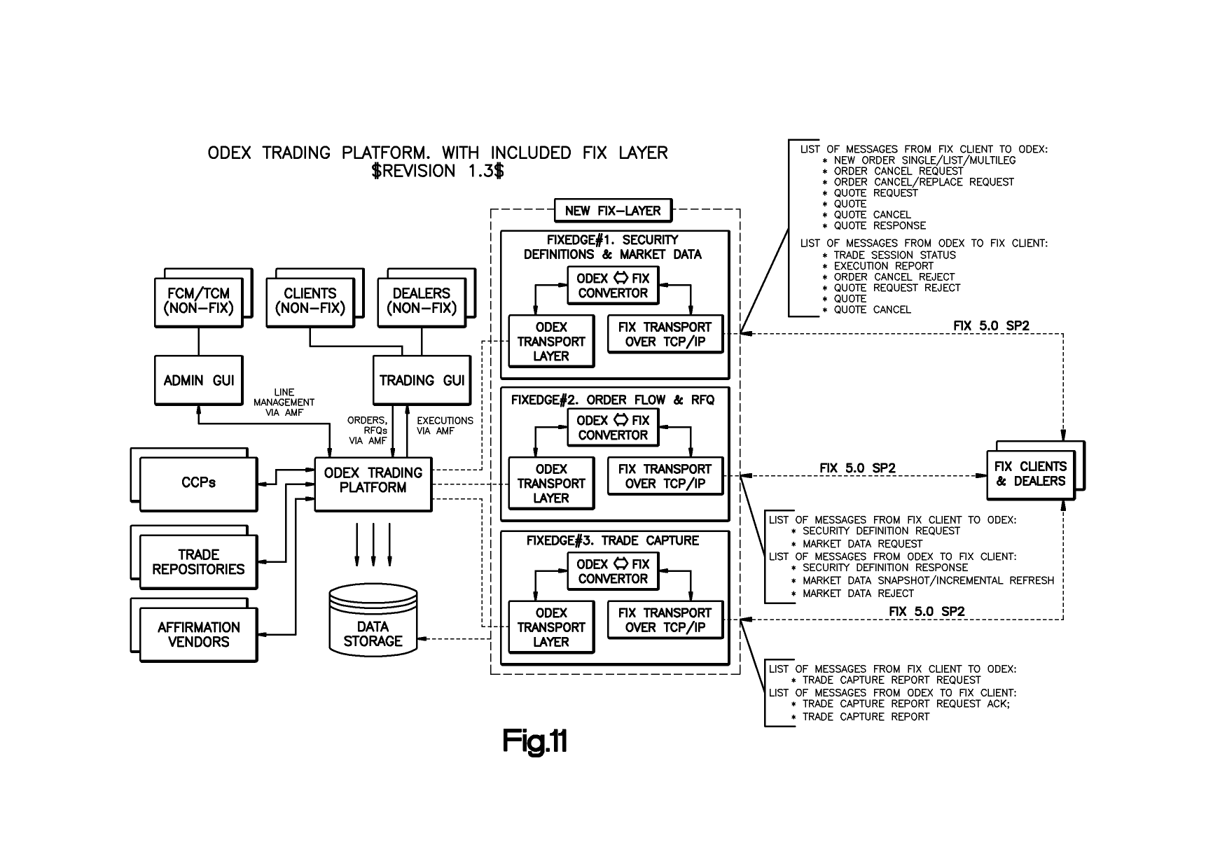

FIG. 11 shows the distributed network system 10 including GUIs (green) used by traders at trading entities and administrators at both the SEF (Odex) and FCM. The central trading platform includes central services such as a matching engine for matching bids and offers and managing the offset model and request for quote. Other services provided by the trading platform include order management, trade confirmation, trade blotters, trade tickets, last traded price, DV01, UPI and contract display.

Users include traders and administrators at trade entities accessing the system directly though the trading GUI. Third, parties include central clearing counterparties (ICE, CME, LCH etc), SDRs or trade repositories and affirmation vendors that provide messaging between all parties (MARKITWIRE, DTCC, ICE, etc.),

Data storage stores UCI, UPI, traders/users, orders and transactions. AMF is the internal SEF messaging protocol for communication between components of the SEF system. External messaging uses FIX protocol—or API using FIX 5 protocol—to allow dealers to connect to the ODEX SEF electronically for order placement and machine-to-machine requests responses.

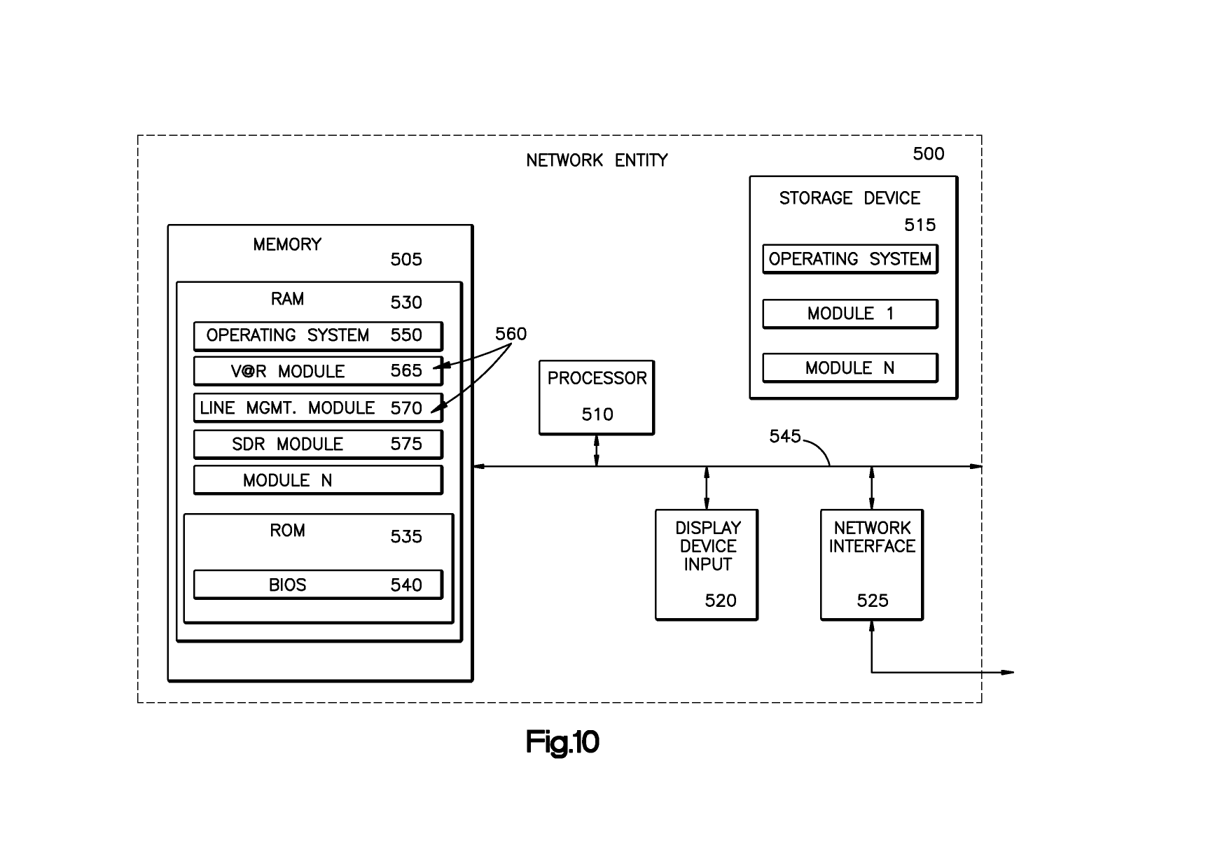

Referring now to FIG. 10, a schematic diagram of a central server 500, or similar network entity, configured to implement a credit line monitoring and communication system is provided. As used herein, the designation “central” merely serves to describe the common functionality the server provides for multiple clients or other computing devices and does not require or infer any centralized positioning of the server relative to other computing devices. As may be understood from FIG. 10, in this embodiment, the central server 500 may include a processor 510 that communicates with other elements within the central server 500 via a system interface or bus 545. Also included in the central server 500 may be a display device/input device 520 for receiving and displaying data. This display device/input device 520 may be, for example, a keyboard or pointing device that is used in combination with a monitor. The central server 500 may further include memory 505, which may include both read, only memory (ROM) 535 and random access memory (RAM) 530. The server's ROM 535 may be used to store a basic input/output system 540 (BIOS), containing the basic routines that help to transfer information across the one or more networks.

In addition, the central server 500 may include at least one storage device 515, such as a hard disk drive, a floppy disk drive, a CD Rom drive, or optical disk drive, for storing information on various computer-readable media, such as a hard disk, a removable magnetic disk, or a CD-ROM disk. As will be appreciated, by one of ordinary skill in the art, each of these storage devices 515 may be connected to the system bus 545 by an appropriate interface. The storage devices 515 and their associated computer-readable media may provide nonvolatile storage for a central server. It is important to note that the computer-readable media described above could be replaced by any other type of computer-readable media known in the art. Such media include, for example, magnetic cassettes, flash memory cards and digital video disks.

A number of program modules may be stored by the various storage devices and within RAM 530. Such program modules may include an operating system 550 and a plurality of one or more (N) modules 560. The modules 560 may control certain aspects of the operation of the central server 500, with the assistance of the processor 510 and the operating system 550. For example, the modules may perform the functions described above and illustrated by the figures and other materials disclosed herein, including a V@R module 565, a line management module 570 and an SDR module 575.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of monitoring credit exposure of trading entities trading derivatives on at least one open exchange, the method comprising;
receiving trade data on an agreed-upon derivative trade from the open exchange, the trade data including a trading entity identification code and contract description data;
determining credit limit data associated with the trading entity identification codes;
determining an amount at risk for the agreed-upon derivative trade using the contract description data;
assigning the amount at risk to the trading entity identification code;
adjusting the credit limit data of the trading entity identification code using the amount at risk;
communicating the adjusted credit limit data for the trading entity identification code to a future commission merchant.

2. A method of claim 1, wherein the credit limit is a daily credit limit.

3. A method of claim 1, wherein communicating includes displaying the adjusted credit limit data for the trading entity identification code on a graphical-user-interface.

4. A method of claim 3, wherein communicating includes displaying trade data of a plurality of derivative trades for the trading entity identification code on the graphical-user-interface.

5. A method of claim 1, further comprising determining when the credit limit data has reached a threshold for the trading entity identification code and communicating a limit warning to the future commission merchant associated with the trading entity identification code.

6. A method of claim 5, further comprising stopping trading by the trading entity identification code in response to the credit limit reaching the threshold.

7. A method of claim 5, further comprising receiving a kill command from the future commission merchant and then stopping trading by the trading entity identification code.

8. A method of claim 1, wherein the trade data includes a first portfolio identification code associated with the entity identification code.

9. A method of claim 8, further comprising communicating the portfolio identification code to the future commission merchant.

10. A method of claim 1, wherein the trade data includes a future commission merchant identification code and wherein communicating the adjusted credit limit data is to the future commission merchant associated, with the future commission merchant identification code.

11. A method of claim 1, wherein determining credit limit data includes receiving the credit limit data from the future commission merchant.

12. A method of claim 1, wherein the credit limit data is based on a multiple of normal market trade sizes.

13. A method of claim 1, wherein the amount at risk is calculated as value at risk.

14. A method of claim 13, wherein adjusting the credit limit data includes increasing the credit limit based on the value at risk.

15. A method of claim 1, further comprising receiving trade data on a plurality of agreed-upon derivative trades by a plurality of trading entity identification codes including receiving trade data from a plurality of open exchanges and wherein the trade data includes open exchange identification data.

16. A method of claim 15, further comprising communicating the trade data for derivative trades for each of the trading entity identification codes to the future commission merchants.

17. A method of claim 16, further comprising filtering the trade data to identify trade data having trading entity identification codes associated with a particular one of the future commission merchants and communicating only the filtered trade data to the particular one of the future commission merchants.

18. A method of claim 17, further comprising removing any price data from the trade data before communicating the trade data to the future commission merchants.

19. A method of claim 18, further comprising sorting the trade data based on closest to trading and communicating the trade data to the future commission merchants.

20. A method of claim 19, farther comprising receiving and communicating historic trade data to the future commission merchants.

21. A method of claim 20, wherein the trade data and historic trade data includes direction data and wherein adjusting the credit limit data includes offsetting trade data and historic trade data when in the direction data is opposite.

22. A hub system for facilitating monitoring of credit exposure of trading entities trading derivatives on at least one swap execution facility, the system including:
a first application program interface (API) connected in communication with one or more future commission merchants, the first API configured to receive information on a trading entity associated with the future commission merchant, determine a unique customer identifier for the trading entity and determine a credit line for the trading entity based on a credit line for the future commission merchant;
a second API connected in communication with one or more swap execution facilities, the second API configured to communicate the credit line for the trading entity to the swap execution facility;
a third API connected in communication with one or more central clearinghouses, the third API configured to communicate the future commission merchant credit line to the central clearinghouse; and
a database configured to store the credit line for the trading entity associated with the unique customer identifier of the trading entity and the future commission merchant credit line.

23. A hub system of claim 22, wherein the hub includes a hold system configured to receive approved trade information and to place a hold on a portion of the credit line for the trading entity associated with an approved trade.

24. A hub system of claim 23, further comprising an update system configured to receive completed trade information and to update the credit line of the trading entity associated with a completed trade.

25. A hub system of claim 24, wherein the approved trae information and completed trade information includes an amount and a unique product identifier and wherein the database includes a plurality of product identifiers.

26. A hub system for facilitating monitoring of credit exposure of trading entities trading derivatives on at least one open exchange, the system including:
a first communication system connected in communication with one or more future commission merchants;
a second communication line connected in communication with one or more open exchanges;
a third communication line connected in communication with one or more central clearinghouses; and
a processor configured to implement the method of claim 1.
